(19) United States
(12) Patent Application Publication
(10) Pub. No.: US 2008/0290819 A1
(43) Pub. Date: Nov. 27, 2008

(54) LIGHT-EMITTING DEVICE DRIVER CIRCUITS AND RELATED APPLICATIONS

(75) Inventors: Christian Hoepfner, North Andover, MA (US); Michael Gregory Brown, Tyngsboro, MA (US); Jeffrey B. Colter, San Diego, CA (US)

Correspondence Address: LUMINUS DEVICES , INC.;C/O WOLF, GREENFIELD & SACKS , P.C., 600 ATLANTIC AVENUE, BOSTON, MA, 02210-2206, US

(73) Assignee: Luminus Devices, Inc., Billerica, MA (US)

(21) Appl. No.: 12/026,815

(22) Filed: Feb. 6, 2008

Related U.S. Application Data
(60) Provisional application No. 60/899,864, filed on Feb. 6, 2007.
(60) Provisional application No. 60/901,009, filed on Feb. 12, 2007.

(51) Int. Cl. H05B 41/36

(52) U.S. Cl. 315/306

(57) ABSTRACT

Driver circuits for light-emitting devices (e.g., light-emitting diodes), as well as systems and methods associated therewith are provided.

### RELATED APPLICATIONS

This application claims priority to U.S. Provisional Patent Application Ser. No. 60/899,864, filed Feb. 6, 2007 and U.S. Provisional Patent Application Ser. No. 60/901,009, filed Feb. 12, 2007, both of which are incorporated herein by reference.

### INCORPORATION BY REFERENCE

This application incorporates by reference U.S. Pat. No. 7,211,831, filed Nov. 26, 2003; U.S. Pat. No. 7,098,589, filed Nov. 26, 2003; U.S. patent application Ser. No. 11/210,262, filed Aug. 23, 2005; U.S. Patent Publication No. 2006/0043391, filed Aug. 23, 2005; U.S. Patent Publication No. 2006/0043400, filed Aug. 23, 2005; and U.S. patent application Ser. No. 11/600,548, filed Nov. 16, 2006.

### FIELD

The present embodiments are drawn generally towards driver circuits for light-emitting devices and/or systems, and more specifically to driver circuits for high-brightness light-emitting device. Specifically, the methods and systems of at least some of the embodiments include driver circuits for high-brightness light-emitting diodes.

### BACKGROUND

A light-emitting diode (LED) can provide light in a more efficient manner than an incandescent light source and/or a fluorescent light source. The relatively high power efficiency associated with LEDs has created an interest in using LEDs to displace conventional light sources in a variety of lighting applications. For example, in some instances LEDs are being used as traffic lights and to illuminate cell phone keypads and displays.

Typically, an LED is formed of multiple layers, with at least some of the layers being formed of different materials. In general, the materials and thicknesses selected for the layers influence the wavelength(s) of light emitted by the LED. In addition, the chemical composition of the layers can be selected to promote isolation of injected electrical charge carriers into regions (commonly referred to as quantum wells) for relatively efficient conversion to light. Generally, the layers on one side of the junction where a quantum well is grown are doped with donor atoms that result in high electron concentration (such layers are commonly referred to as n-type layers), and the layers on the opposite side are doped with acceptor atoms that result in a relatively high hole concentration (such layers are commonly referred to as p-type layers).

LEDs also generally include contact structures (also referred to as electrical contact structures or electrodes), which are conductive features of the device that may be electrically connected to an electrical driver circuit. The driver can provide electrical current to the device via the contact structures, e.g., the contact structures can deliver current along the lengths of structures to the surface of the device within which light may be generated.

### SUMMARY

Driver circuits for light-emitting devices, and methods associated therewith are provided.

In one aspect, a system is provided. The system comprises an LED and a driver circuit configured to drive the LED/The driver circuit comprising a shunt switch having a source terminal and a drain terminal configured to be in parallel with the LED and further configured to serve as a current shunt path for the LED when the shunt switch is closed. The driver circuit further comprising a current regulator configured to provide current to the LED when the shunt switch is opened.

In another aspect, an LED driver circuit for an LED load is provided. The circuit comprises a shunt switch having a source terminal and a drain terminal configured to be in parallel with the LED load and further configured to serve as a current shunt path for the LED load when the shunt switch is closed. The circuit further comprises a current regulator configured to provide current to the LED load when the shunt switch is opened.

In another aspect, a method for driving an LED is provided. The method comprises driving an LED using a driver circuit. The driver circuit comprises a shunt switch having a source terminal and a drain terminal configured to be in parallel with the LED and further configured to serve as a current shunt path for the LED when the shunt switch is closed. The driving circuit further comprises a current regulator configured to provide current to the LED when the shunt switch is opened.

Other aspects, embodiments and features of the invention will become apparent from the following detailed description of the invention when considered in conjunction with the accompanying figures. The accompanying figures are schematic and are not intended to be drawn to scale. In the figures, each identical or substantially similar component that is illustrated in various figures is represented by a single numeral or notation.

For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF FIGURES

FIG. 1 is a current versus forward voltage profile of a red light-emitting diode (LED);

FIG. 2 is a current versus forward voltage profile of a blue LED;

FIG. 3 is a current versus forward voltage profile of a green LED;

FIG. 4 is a current versus reverse voltage profile of a red LED;

FIG. 5 is a current versus reverse voltage profile of a blue LED;

FIG. 6 is a current versus reverse voltage profile of a green LED;

FIG. 7 is a schematic circuit diagram of a linear current regulator driver for an LED;

FIG. 8 is a schematic circuit diagram of a switched shunt driver for an LED;

FIG. 9 shows simplified waveform diagrams when using an hysteretic current control method;

FIG. 10 is a schematic circuit diagram of a multiphase staggered switching regulator;

FIG. 11 is a schematic circuit diagram of a circuit including a series resistor-capacitor (RC) damping circuit connected in parallel with the load LED;

FIG. 12 shows measured waveforms for a typical long current pulse applied to a green LED with voltage shown as trace 1 and current as trace 2;

FIGS. 13 and 14 shows zoom-in waveforms of the waveforms of FIG. 12 showing rise and fall times, respectively;

FIG. 15 shows measured waveforms showing ringing using fast rise and fall times;

FIG. 16 shows measured waveforms showing the effect of damping with an RC network;

FIG. 17 shows measured waveforms showing the additional effect of a reverse clamping diode;

FIG. 18 shows a schematic circuit diagram of a switched shunt driver for an LED; and

FIG. 19 shows a schematic drawing light emitting die.

### DETAILED DESCRIPTION

High-power LEDs (e.g., high-brightness LEDs) represent a breakthrough in technology allowing an order of magnitude more light output than previously possible. Conventional high-power LEDs typically operate at power levels less than about 1 Watt, but some recently developed high-power LEDs can consume about 50 Watts (or greater) of electrical power with a corresponding increase in light output. To achieve these high power levels of operation, high-power LEDs can be driven by electrical driver circuits that provide large electrical currents. However, traditional large-current electrical driver circuits may have large rise and fall times due to the response time of circuit elements such as inductors and/or capacitors. In applications where both high drive current and fast rise and fall times are desired to drive LEDs, conventional electrical drivers may not be adequate. Embodiments presented herein may provide for both high drive current and fast rise and fall times to drive one or more LEDs, such as one or more high-power LEDs. In some embodiments, one or more LEDs are driven by controlled current pulses in the range of a few amps up to as much as 15 amps, with rise times of about a few microseconds, pulse duty cycles between a few percent up to continuous operation, and with compliance voltages ranging from 10 to 50 volts.

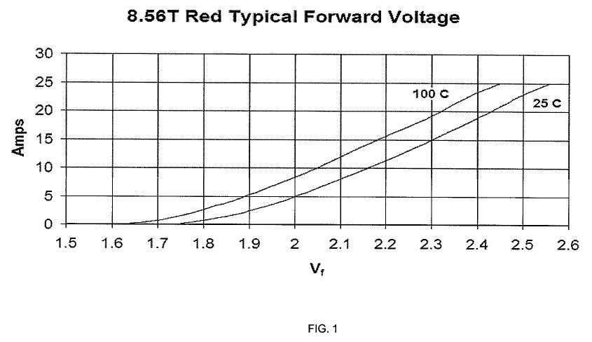

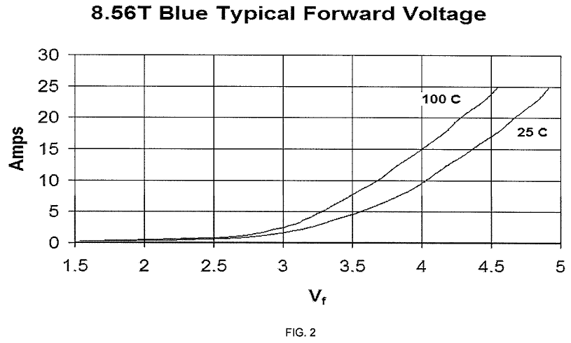

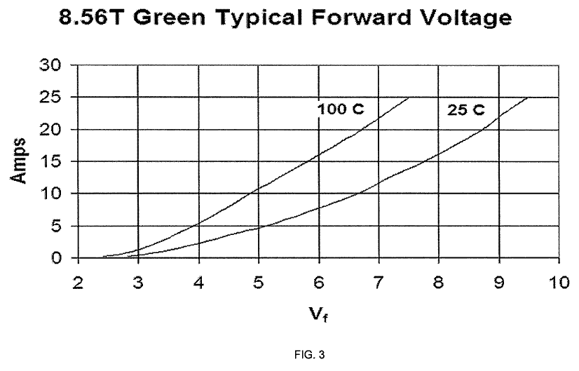

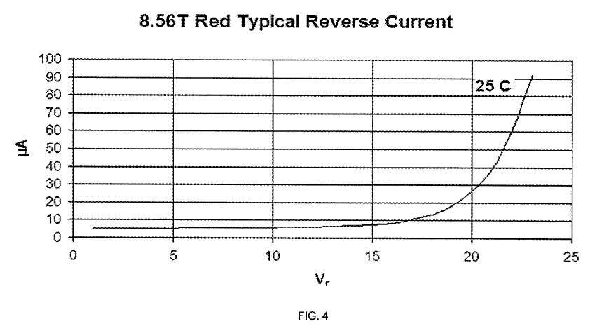

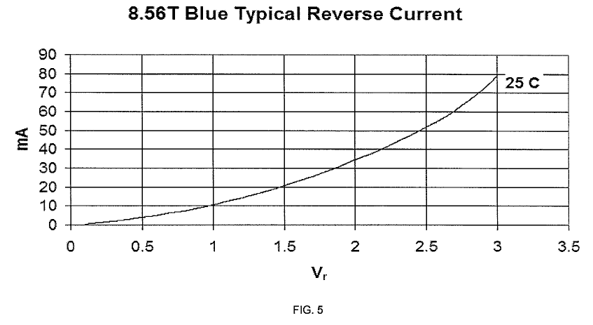

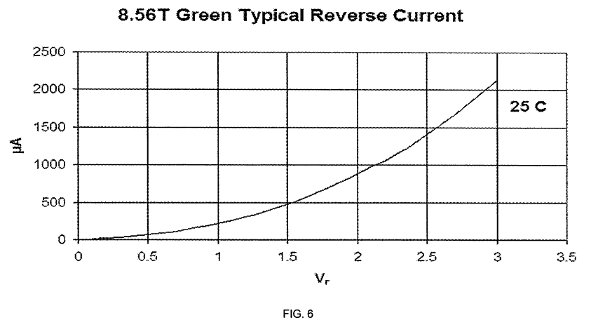

High-powers LEDs can have forward conduction modes similar to typical diodes with some forward voltage profiles as shown in FIGS. 1-3. Significant forward voltage differences may be present between LEDs that emit different wavelengths of light. High-power LEDs may have higher reverse leakage currents as compared with typical diodes as shown in FIGS. 4-6. Typically, leakage current increases with temperature. Furthermore, typical blue-emitting high-power LEDs can have much higher leakage current, as should be appreciated by the vertical milliamp scale of the data plot of FIG. 5.

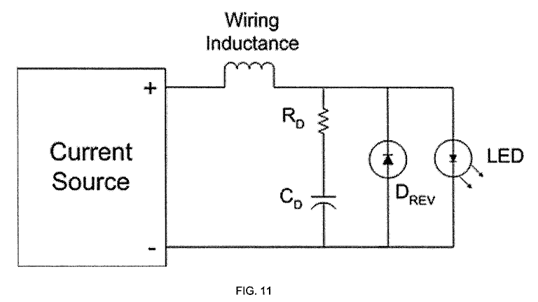

A reverse clamping diode D_{REV} may be arranged in parallel with a high-power LED to prevent reverse conduction and possible device damage. Such a circuit configuration is shown in FIG. 11. In some embodiments, a packaged LED includes a reverse clamping diode. In some embodiments, the reverse clamping diode is a separate component disposed on a common board with the LED. In other embodiments, the reverse clamping diode is part of the light-emitting die. The reverse clamping diode device can be a transient voltage suppressor (e.g., rated at about 36 volts or greater), such as an ON Semiconductor SMF36AT1 diode, however it should appreciated that other suitable reverse clamping diodes may be used, as the embodiments are not limited in this respect.

Drivers

LEDs are essentially diodes whose light output intensity is proportional to current. Therefore, typically the value of the current is regulated to control the light intensity emitted by the LED. The electrical model of the LED in its simplest form is a perfect diode in series with some resistance. A perfect diode has a voltage drop independent of the current. Some additional voltage may therefore be required to overcome the voltage drop in the series resistance.

Current flow can be established simply by connecting the LED to a DC power supply whose output voltage is close to the voltage drop of the LED, however current would be limited by the series resistance of the circuit including the power supply, wiring, and that intrinsic to the LED itself. In addition, the voltage drop through the LED varies from device to device and is temperature dependent which can make precise control of current difficult using only a fixed voltage source. In some embodiments, an electronic circuit may be used to sense the LED current and feedback the signal to a control element that in turn can regulate the current and hence the light output to the desired value.

In some embodiments, controlling current through an LED circuit can include linear current regulation and/or switching regulation.

Linear Regulator

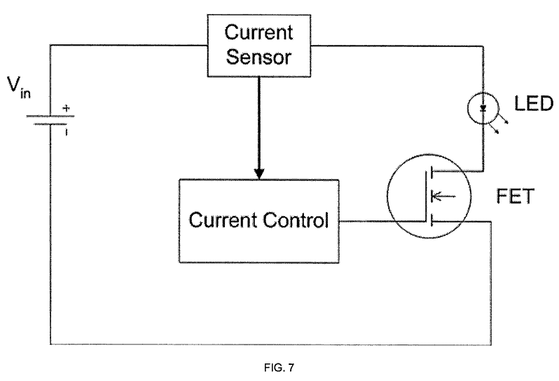

In some embodiments, a linear regulator driver uses a series device, usually a transistor (e.g., a FET, such as a MOSFET), that acts as a controlled variable resistor to regulate current through the circuit in response to feedback from a current sensor. The principal advantage of a linear current regulator is the absence of ripple current. FIG. 7 shows a block diagram of a linear current regulator circuit driving an LED, in accordance with one embodiment.

Because the power supply must supply a voltage somewhat higher than the forward voltage of the LED in order to control the current, a considerable amount of power may be wasted in the series transistor of the linear current regulator driver. This voltage, known as the compliance voltage, may be made as low as is necessary to control current over the range of forward voltage expected due to device and temperature differences. Achieving fast rise and fall times with a linear current regulator can be challenging because the feedback circuit needs to be stable under all operating conditions. This may require specific knowledge of the parasitic capacitance and inductance of the load as these parasitics can directly influence stability. In some embodiments, the regulator feedback circuit may be tuned to a particular load to achieve fast rise and fall times.

The linear regulator method can use a FET transistor as a series pass element or variable resistor, between the source voltage and the load, to regulate the current. The linear regulator method can thus produce accurate and smooth current waveforms. Pulse rise time may be dependent on the speed of the FET and the wiring inductance. The circuit dynamics may be dependent on the load however, so some care must be taken to stabilize the regulator and tailor the response time to avoid overshoot for a given load and wiring inductance. At currents around five amps or so, efficiency is greater than or equal to about 80%. For example, using a six-pack array of LEDs at 5 amps and 40 volts, and using a source of 50 volts, the power loss is about 50 watts-all in the pass transistor, and the efficiency is about 80%. It should be appreciated that in this example, the FET transistor may dissipate 50 watts and hence heat sinking may be used, for example using a fan cooled heat sink. Slew rate may also inherently be very high. Another consideration may be switching noise which may be completely absent with the linear regulator method.

For a linear regulator, output current pulse rise and fall times (e.g., for pulse wave operation) may be dependent on the compliance voltage, circuit capacitance, the switching speed of the controlling device (e.g., transistor), and/or the control circuit.

Switching Regulator

In some embodiments, a high frequency switching regulator controls current by using an inductor to average high frequency voltage pulses from a switching element, usually a transistor. The duty cycle of the high frequency switching element can be controlled by a feedback signal from a current sensor. The duty cycle can influence the average inductor current which may be mostly DC with a small, high frequency AC ripple current. Several different circuit topologies for such a switching regulator are possible, for example, a ‘buck’ or step-down regulator topology may be used.

In some embodiments, a drive current for an LED is a continuous wave (CW) current. In other embodiments, a drive current for an LED is a pulsed wave current. A pulsed wave current may present some circuit constraints. The rise and fall times of the current pulses may be set by design. In some embodiments, current pulse rise and fall times are greater than 0.5 microseconds. For a switching regulator, current can be pulsed using a switched shunt method or high-bandwidth switching method, as discussed further below.

Switched Shunt

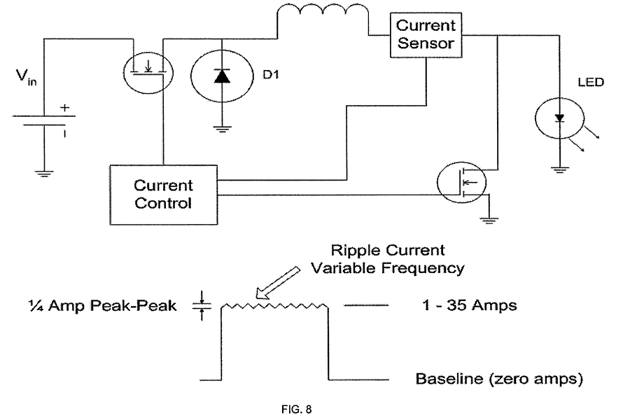

In a first embodiment for pulsing current, a buck topology switching regulator may be used to produce continuous current. Alternatively, other types of continuous current sources may be used, as the techniques are not limited in this respect. A switching element (e.g., a transistor, such as a MOSFET) may be used to shunt the current away from the load LED when not needed (e.g., pulse mode). Such a method is referred to herein as a shunt method. The shunt transistor can be connected in parallel with the load LED and essentially short-circuits the current source so that current does not flow through the load LED. The rise and fall times of the current pulses may be determined by the switching speed of the shunt transistor and the high frequency impedance (wiring inductance) in series with the load LED. An LED driver circuit that uses a shunt control method is shown in FIG. 8. The efficiency of this technique may be higher than the linear method, however current flows continuously in most of the circuit which may consume power needlessly when the LED is off.

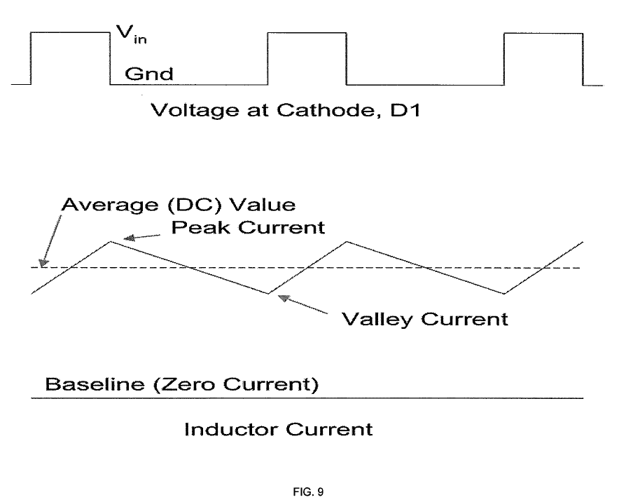

A hysteretic current control method may be used to control the current level. Such a method may produce some small amplitude waveform ripples. Simplified waveforms are shown in FIG. 9. To achieve very fast rise and fall times, an output capacitor may be absent to reduce the ripple amplitude. The current controller can switch back and forth between two current levels that form the hysteresis band. The switching frequency is typically in the hundreds of kilohertz so as to ensure that the size of the inductor reasonable. The disadvantage of the hysteretic current control technique is reduced accuracy of the resulting current in the LED due to the ripple variation. However, the average current can be controlled fairly accurately (e.g., determined by component tolerances and the current sensor accuracy) and the high frequency ripple may not be of consequence in a particular application.

In the switched shunt method, a continuous current may therefore be established in a large inductor using, for example, the hysteretic current regulator circuit. That current can flow continuously through either the load (e.g., LED) or through the shunt switch (e.g., a transistor such as a MOSFET). The design may be simple and stable. The hysteretic regulator operation may be load independent, and thus may operate independent of the dynamics of the load. The hysteretic regulator can simply maintain the current in the inductor between two set values, e.g., 10 and 10.5 amps. The difference between the two set values is called the ripple current and may be triangular in shape. The ripple current can be minimized but a tradeoff may be the switching frequency which may have a practical upper limit. The rise time of the output current pulse may depend on the switching speed of the shunt transistor and the wiring inductance between the shunt transistor and the LED load. The rise time can be in the sub microsecond range (e.g., less than about 1 microsecond, less than about 0.5 microseconds, less than 0.25 microseconds). The current shunted can be greater than or equal to about 10 amps (e.g., greater than 15 amps, greater than 20 amps). The efficiency of a switched shunt regulator may be relatively high because of the switching design, however, some loss of efficiency may be inherent as current may also be circulated when not needed by the load.

High-Bandwidth Switching

In a second embodiment for pulsing current, a current is only established when needed by the LED load and the current is thus ramped from zero to the desired level for each pulse. In this case, the rise and fall times of the current may be determined by the bandwidth of the regulator control circuit. This method may be more efficient and can have higher power density than the shunt method but may be more complex. In order to minimize ripple current some output capacitance may be used. A conventional DC power supply topology configured to control current rather than voltage may be used but rise and fall times of the LED current pulses may be limited by the output capacitance. If the rise and fall time requirements are not too fast (e.g., a few dozen microseconds) such a technique may provide for a pulsed current with reduced ripple.

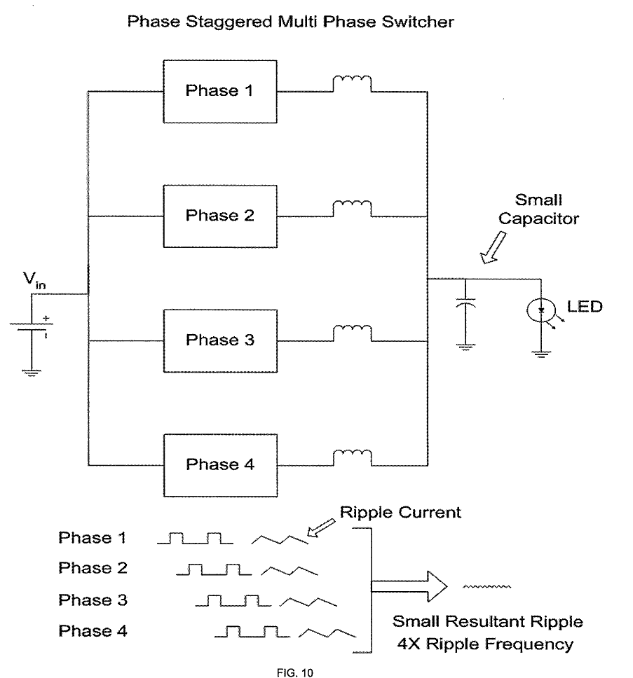

In some embodiments, higher regulator bandwidth may be used for rise and fall times in the one-microsecond range. One way of achieving high regulator bandwidth is to use multiphase staggered switching regulators as shown in the circuit of FIG. 10. The effective switching frequency is a multiple of the number of paralleled stages. Such a circuit can allow for a reduction in the size of the output filter capacitor and hence increase the transient response time of the current regulator. Such a drive technique can provide for high efficiency with minimal ripple current.

Therefore, high-bandwidth switching is also a switching type regulator but this method does not circulate current when not needed in the load. A high-bandwidth switcher only generates current in the load when needed, and therefore the current regulator should be very fast as the current starts from zero and ramps up to the set value (e.g., in a few microseconds). This may be a difficult requirement for a straight switching regulator, as control bandwidth is related to switching frequency which may have a practical upper limit due to efficiency and other considerations. To overcome this limitation, a multiphase regulator can be used to achieve high regulator bandwidth without having to increase switching frequency beyond a practical limit. Typically, several (N) switching regulators (e.g., which may be identical) can share current in parallel, and a control integrated circuit (IC) can balance load current between the stages and stagger the phase of the switching waveforms to minimize ripple. A multiphase regulator can have an effective switching frequency (and thus bandwidth) of N times that of one stage, yet each stage can operate at a practical switching frequency. It may be possible to extend the capabilities of a single stage, balancing pulse rise time against switching frequency and efficiency. A multiphase regulator circuit can slew current quickly from one LED to another LED at a different load voltage, since the multiphase regulator is able to slew current quickly from zero to a set value.

In some embodiments of a multiphase switching regulator, efficiency is better than 95%, and power loss is distributed amongst several components such that fan cooling may be optional.

Load Considerations

Electrical connections between a current source (e.g., the electrical driver of the LED) to the LED can be made with conductors large enough to carry the RMS current expected and can be arranged to minimize wiring inductance by minimizing the distance from the current source to the LED and the loop area between the conductors. When using wires to establish the electrical connection, the LED connection wires can be twisted together and/or overlapping, insulated copper ribbon foil may be used. When using a printed circuit board, overlapping traces on adjacent layers may be used. Excessive inductance can cause the output waveform to ring (e.g., under-damped resonance) with the stray wiring and LED capacitance and cause voltage/current overshoots and undershoots that could damage the LED load and generate EMI. The severity of the ringing can be dependent on the rise and fall times of the current pulse. A sufficiently slow rise time may not cause serious ringing, but for typical rise and fall times, on the order of a few microseconds or less, ringing may occur.

In some embodiments, a series resistor-capacitor damping circuit may be electrically coupled across the load LED, as shown in FIG. 11. Acceptable values for the capacitor (C_{D}) and resistor (R_{D}) which can provide adequate damping can be determined using measurements and/or using simulation. A method of determining the capacitor (C_{D}) and resistor (R_{D}) values using measurements may involve, with the load connected and operating, observing (e.g., using an oscilloscope) a ringing voltage waveform across the LED. This ringing occurs at the transition of the current pulse.

The value of stray capacitance may be in the range of a few hundred to a few thousand picofarads, and may be mostly due to the LED itself. While observing the ringing waveform on an oscilloscope, capacitors may be added directly across the LED, a few hundred pf at a time (e.g., using capacitors with the shortest leads so as not to introduce inductance in series with the capacitor), and the change in ringing frequency may be observed. The capacitance can be increased until the ringing frequency is halved. At this point the total circuit capacitance is four times the original value which implies that the added capacitance is three times the original value. This added capacitance may be an adequate value for the damping circuit (snubber) since the circuit Q is near unity and therefore adequately damped. Once the original circuit capacitance Cᵢ is determined from this procedure, the circuit inductance can be calculated with the following formula where f is the original frequency:

$$L = \frac{1}{{( 2 π f )}^{2} {C}_{i}} . \qquad [ 1 ]$$

The series resistor value for optimum damping is then equal to the characteristic (surge) impedance of the circuit:

$${R}_{OPT} = \sqrt{\frac{L}{{C}_{i}}} . \qquad [ 2 ]$$

A simpler calculation can be made by substituting equation [1] into [2] resulting in the expression:

$${R}_{OPT} = \frac{1}{2 π {fC}_{i}} , \qquad [ 3 ]$$

which is also the expression for X_{C}, the reactance of the original circuit capacitance at the original frequency. The units are R in ohms, C in Farads, L in Henries, and f in Hertz.

For example, 1 nF of LED capacitance and 1 μH of inductance (from several inches of untwisted LED leads) rings at about 5 MHz. The surge impedance is then 31 ohms (from Eq. 2 or 3). A 3.9 nF capacitor with a standard 33 ohm resistor in series will then optimally damp out the oscillations. Because the repetition rate for the oscillations is low (usually a few hundred Hertz) the power dissipated in this resistor is negligible and a ¼ Watt carbon composition type may be adequate. The power dissipated in the resistor is independent of the resistor value and is given by the following equation:

P_{D}=C_{D}V_{f}²fₘ, [4]

where V_{f} is the LED forward voltage and fₘ is the repetition rate of the pulsed current. The capacitor can be a ceramic type X7R, COG, or mica dielectric and may be rated for at least 100 volts.

The RMS value for a square wave of current is:

I_{RMS}=I_{PK}\sqrt{D}, [5]

where I_{PK} is the peak LED current and D is the duty cycle.

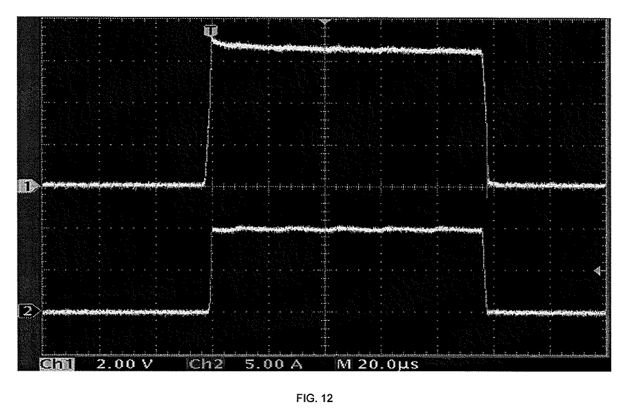

FIG. 12 shows a typical 10 amp, 100 microseconds long current pulse applied to a green LED with voltage shown on trace 1 and current on trace 2. This circuit has minimal external inductance and therefore ringing is not noticeably present. Note the slight (¼ amp peak to peak) ripple current produced by the hysteretic current controller used in the current source that was used to supply current. FIG. 12 also shows a slight peaking of the voltage at the beginning of the pulse, which may be caused by rapid localized heating of small portions of the device structure.

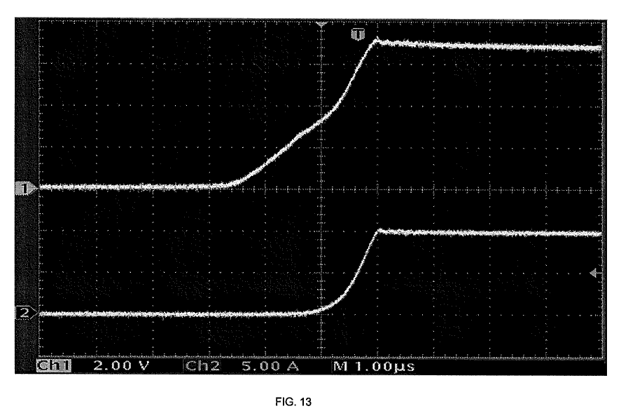

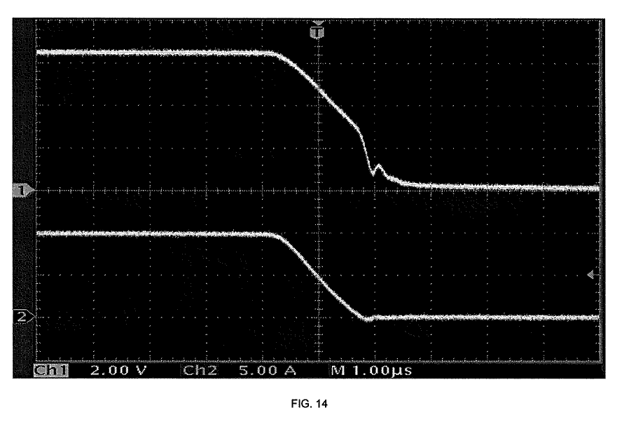

FIGS. 13 and 14 are traces showing rise and fall times of approximately 1 microsecond. FIG. 13 shows that the voltage rises slowly before current flows in the LED. The slow turn-on of the LED is the result of the intentional slow turn off time of the shunt transistor used in the current source for this measurement.

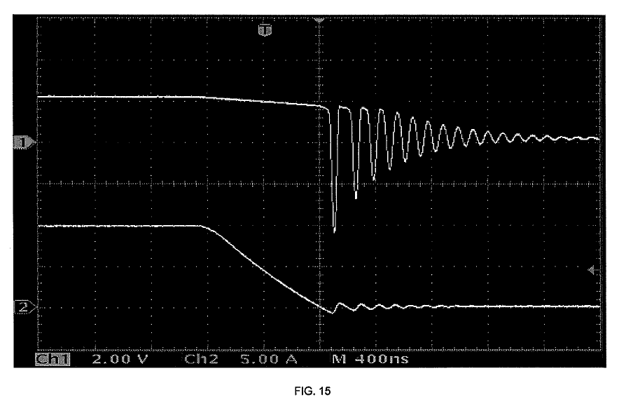

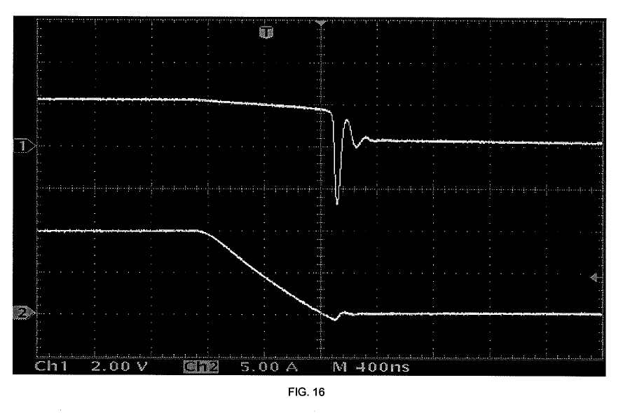

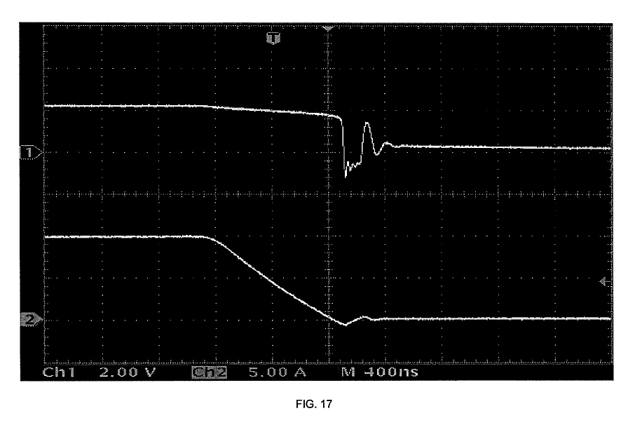

Ringing may become increasingly noticeable with faster rise and fall times. FIG. 15 shows more ringing with faster rise and fall times. FIG. 16 shows the effect of damping with an RC network and FIG. 17 shows the additional effect of the recommended reverse clamping diode.

Measurements were performed using a Tektronix TDS 3034B oscilloscope and a TC202, 50 MHz current probe.

### WORKING EXAMPLE

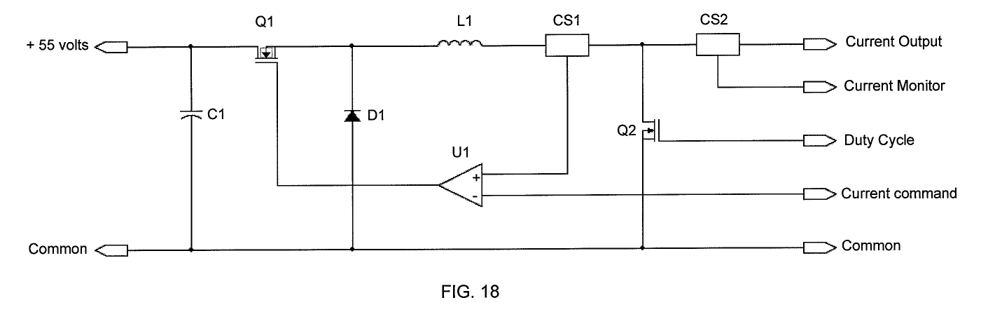

FIG. 18 shows a circuit schematic of a switch shunt regulator current source driver. The driver may be used to drive one or more LEDs having their cathodes and anodes connected between the Current Output node and the Common node.

The driver shown in FIG. 18 may be a current-source having a switching mode power supply configured to control output current rather than the usual voltage. The input to the switching regulator can be a regulated DC voltage (e.g., approximately 55 volts in one embodiment), which can be supplied by an internal off-the-shelf commercial power supply. In one embodiment, the power supply can have a maximum capacity of 300 watts at its nominal 48 volt output. Since the power supply can be adjusted up to 55 volts, and the power rating can be determined by the maximum available current, more than 300 watts can actually be available at 55 volts. The efficiency of the current source may be about the same as this ratio, and therefore about 300 watts can be available at the current output of the current source.

In one embodiment, the switching circuit topology (i.e., current regulator) is a standard buck regulator operating as a hysteretic current controller. Current sensor CS1 can sense current in the inductor and can control transistor switch Q1. When current is first commanded, transistor switch Q1 is turned on until current in the inductor reaches the value commanded (peak current), at which point the comparator U1 state flips and transistor switch Q1 is turned off. Current can then continue to flow and decay in inductor L1 and diode D1. When the current then decays below the hysteretic threshold (valley current) the comparator U1 can flip back the other way and turn transistor switch Q1 on again, and the cycle repeats. The inductor L1 can average the switching function into a DC current with a small (e.g., ¼ Amp) ripple current superimposed on the DC current. The hysteretic controller can vary in duty cycle and frequency. The amplitude of the ripple current can be reduced by increasing the frequency for a given inductor size. FIG. 9 illustrates representative waveforms of such an embodiment.

In one embodiment, input capacitor C1 may be connected across the input voltage node and the common node. The input capacitor can store energy and averages out large peak currents drawn by the switching circuit in the current source.

The current regulator can maintain a constant current (with a small-amplitude ripple) in the inductor. Transistor switch Q2 can shunt the current away from the load (e.g., one or more load LEDs) by shorting the output of the current source. The duty cycle of transistor switch Q2 is this the inverse of the duty cycle of current flowing in the load LED(s).

In some embodiments, the input voltage range of the current source driver is between about 100-240 V (AC). The input voltage can have a 4.4 amps maximum current. The input voltage can have a frequency of about 50 to 60 Hz. In some embodiments, an output of duty cycle of about 0% to 100%. The output current can be about 1 amp to about 35 amps. The output current may be limited to about 300 watts maximum power. A typical ripple current may be about 250 mA p-p sawtooth wave with a frequency of about 10-100 KHz. Current rise and fall times may be about 1 μs (with minimal wiring inductance). Voltage compliance may be about 40 volts maximum.

Light-Emitting Devices

The driver circuits presented herein may be used to drive one or more light-emitting devices, including but not limited to LEDs and/or laser diodes. The driven light-emitting devices may be high-power devices and may be high-brightness light-emitting devices.

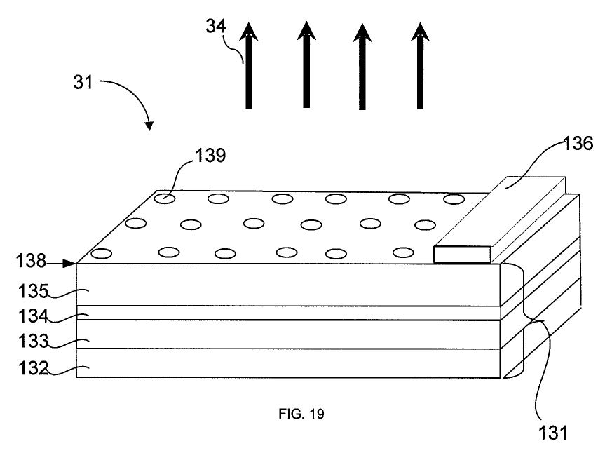

FIG. 19 illustrates a light-emitting diode (LED) die that may be the light-generating component of a light-emitting device, in accordance with one embodiment. It should also be understood that various embodiments presented herein can also be applied to other light-emitting devices, such as laser diodes, and LEDs having different structures (such as organic LEDs, also referred to as OLEDs). The LED 31 shown in FIG. 19 comprises a multi-layer stack 131 that may be disposed on a support structure (not shown). The multi-layer stack 131 can include an active region 134 which is formed between n-doped layer(s) 135 and p-doped layer(s) 133. The stack can also include an electrically conductive layer 132 which may serve as a p-side contact, which can also serve as an optically reflective layer. An n-side contact pad 136 is disposed on layer 135. It should be appreciated that the LED is not limited to the configuration shown in FIG. 19, for example, the n-doped and p-doped sides may be interchanged so as to form a LED having a p-doped region in contact with the contact pad 136 and an n-doped region in contact with layer 132. As described further below, electrical potential may be applied to the contact pads which can result in light generation within active region 134 and emission of at least some of the light generated through an emission surface 138. As described further below, openings 139 may be defined in a light-emitting interface (e.g., emission surface 138) to form a pattern that can influence light emission characteristics, such as light extraction and/or light collimation. It should be understood that other modifications can be made to the representative LED structure presented, and that embodiments are not limited in this respect.

The active region of an LED can include one or more quantum wells surrounded by barrier layers. The quantum well structure may be defined by a semiconductor material layer (e.g., in a single quantum well), or more than one semiconductor material layers (e.g., in multiple quantum wells), with a smaller electronic band gap as compared to the barrier layers. Suitable semiconductor material layers for the quantum well structures can include InGaN, AlGaN, GaN and combinations of these layers (e.g., alternating InGaN/GaN layers, where a GaN layer serves as a barrier layer). In general, LEDs can include an active region comprising one or more semiconductors materials, including III-V semiconductors (e.g., GaAs, AlGaAs, AlGaP, GaP, GaAsP, InGaAs, InAs, InP, GaN, InGaN, InGaAlP, AlGaN, as well as combinations and alloys thereof), II-VI semiconductors (e.g., ZnSe, CdSe, ZnCdSe, ZnTe, ZnTeSe, ZnS, ZnSSe, as well as combinations and alloys thereof), and/or other semiconductors. Other light-emitting materials are possible such as quantum dots or organic light-emission layers.

The n-doped layer(s) 135 can include a silicon-doped GaN layer (e.g., having a thickness of about 4000 nm thick) and/or the p-doped layer(s) 133 include a magnesium-doped GaN layer (e.g., having a thickness of about 40 nm thick). The electrically conductive layer 132 may be a silver layer (e.g., having a thickness of about 100 nm), which may also serve as a reflective layer (e.g., that reflects upwards any downward propagating light generated by the active region 134). Furthermore, although not shown, other layers may also be included in the LED; for example, an AlGaN layer may be disposed between the active region 134 and the p-doped layer(s) 133. It should be understood that compositions other than those described herein may also be suitable for the layers of the LED.

As a result of openings 139, the LED can have a dielectric function that varies spatially according to a pattern. The dielectric function that varies spatially according to a pattern can influence the extraction efficiency and/or collimation of light emitted by the LED. In some embodiments, a layer of the LED may have a dielectric function that varies spatially according to a pattern. In the illustrative LED 31, the pattern is formed of openings, but it should be appreciated that the variation of the dielectric function at an interface need not necessarily result from openings. Any suitable way of producing a variation in dielectric function according to a pattern may be used. For example, the pattern may be formed by varying the composition of layer 135 and/or emission surface 138. The pattern may be periodic (e.g., having a simple repeat cell, or having a complex repeat super-cell), or non-periodic. As referred to herein, a complex periodic pattern is a pattern that has more than one feature in each unit cell that repeats in a periodic fashion. Examples of complex periodic patterns include honeycomb patterns, honeycomb base patterns, (2×2) base patterns, ring patterns, and Archimedean patterns. In some embodiments, a complex periodic pattern can have certain holes with one diameter and other holes with a smaller diameter. As referred to herein, a non-periodic pattern is a pattern that has no translational symmetry over a unit cell that has a length that is at least 50 times the peak wavelength of light generated by one or more light-generating portions. Examples of non-periodic patterns include aperiodic patterns, quasi-crystalline patterns (e.g., quasi-crystal patterns having 8-fold symmetry), Robinson patterns, and Amman patterns. A non-periodic pattern can also include a detuned pattern (as described in U.S. Pat. No. 6,831,302 by Erchak, et al., which is incorporated herein by reference). In some embodiments, a device may include a roughened surface. The surface roughness may have, for example, a root-mean-square (rms) roughness about equal to an average feature size which may be related to the wavelength of the emitted light.

In certain embodiments, an interface of a light-emitting device is patterned with openings which can form a photonic lattice. Suitable LEDs having a dielectric function that varies spatially (e.g., a photonic lattice) have been described in, for example, U.S. Pat. No. 6,831,302 B2, entitled “Light Emitting Devices with Improved Extraction Efficiency,” filed on Nov. 26, 2003, which is herein incorporated by reference in its entirety. A high extraction efficiency for an LED implies a high power of the emitted light and hence high brightness which may be desirable in various optical systems.

It should also be understood that other patterns are also possible, including a pattern that conforms to a transformation of a precursor pattern according to a mathematical function, including, but not limited to an angular displacement transformation. The pattern may also include a portion of a transformed pattern, including, but not limited to, a pattern that conforms to an angular displacement transformation. The pattern can also include regions having patterns that are related to each other by a rotation. A variety of such patterns are described in U.S. patent application Ser. No. 11/370,220, entitled “Patterned Devices and Related Methods,” filed on Mar. 7, 2006, which is herein incorporated by reference in its entirety.

Light may be generated by the LED as follows. The p-side contact layer can be held at a positive potential relative to the n-side contact pad, which causes electrical current to be injected into the LED. As the electrical current passes through the active region, electrons from n-doped layer(s) can combine in the active region with holes from p-doped layer(s), which can cause the active region to generate light. The active region can contain a multitude of point dipole radiation sources that generate light with a spectrum of wavelengths characteristic of the material from which the active region is formed. For InGaN/GaN quantum wells, the spectrum of wavelengths of light generated by the light-generating region can have a peak wavelength of about 445 nanometers (nm) and a full width at half maximum (FWHM) of about 30 nm, which is perceived by human eyes as blue light. The light emitted by the LED may be influenced by any patterned interface through which light passes, whereby the pattern can be arranged so as to influence light extraction and/or collimation.

In other embodiments, the active region can generate light having a peak wavelength corresponding to ultraviolet light (e.g., having a peak wavelength of about 370-390 nm), violet light (e.g., having a peak wavelength of about 390-430 nm), blue light (e.g., having a peak wavelength of about 430-480 nm), cyan light (e.g., having a peak wavelength of about 480-500 nm), green light (e.g., having a peak wavelength of about 500 to 550 nm), yellow-green (e.g., having a peak wavelength of about 550-575 nm), yellow light (e.g., having a peak wavelength of about 575-595 nm), amber light (e.g., having a peak wavelength of about 595-605 nm), orange light (e.g., having a peak wavelength of about 605-620 nm), red light (e.g., having a peak wavelength of about 620-700 nm), and/or infrared light (e.g., having a peak wavelength of about 700-1200 nm).

In certain embodiments, the LED may emit light having a high power. As previously described, the high power of emitted light may be a result of a pattern that influences the light extraction efficiency of the LED. For example, the light emitted by the LED may have a total power greater than 0.5 Watts (e.g., greater than 1 Watt, greater than 5 Watts, or greater than 10 Watts). In some embodiments, the light generated has a total power of less than 100 Watts, though this should not be construed as a limitation of all embodiments. The total power of the light emitted from an LED can be measured by using an integrating sphere equipped with spectrometer, for example a SLM12 from Sphere Optics Lab Systems. The desired power depends, in part, on the optical system that the LED is being utilized within. For example, a display system (e.g., a LCD system) may benefit from the incorporation of high brightness LEDs which can reduce the total number of LEDs that are used to illuminate the display system.

The light generated by the LED may also have a high total power flux. As used herein, the term “total power flux” refers to the total power divided by the emission area. In some embodiments, the total power flux is greater than 0.03 Watts/mm², greater than 0.05 Watts/mm², greater than 0.1 Watts/mm², or greater than 0.2 Watts/mm². However, it should be understood that the LEDs used in systems and methods presented herein are not limited to the above-described power and power flux values.

In some embodiments, the LED may be associated with a wavelength-converting region. The wavelength-converting region may be, for example, a phosphor region. The wavelength-converting region can absorb light emitted by the light-generating region of the LED and emit light having a different wavelength than that absorbed. In this manner, LEDs can emit light of wavelength(s) (and, thus, color) that may not be readily obtainable from LEDs that do not include wavelength-converting regions.

As used herein, an LED may be an LED die, a partially packaged LED die, or a fully packaged LED die. It should be understood that an LED may include two or more LED dies associated with one another, for example a red-light emitting LED die, a green-light emitting LED die, a blue-light emitting LED die, a cyan-light emitting LED die, or a yellow-light emitting LED die. For example, the two or more associated LED dies may be mounted on a common package. The two or more LED dies may be associated such that their respective light emissions may be combined to produce a desired spectral emission. The two or more LED dies may also be electrically associated with one another (e.g., connected to a common ground).

As used herein, when a structure (e.g., layer, region) is referred to as being “on”, “over” “overlying” or “supported by” another structure, it can be directly on the structure, or an intervening structure (e.g., layer, region) also may be present. A structure that is “directly on” or “in contact with” another structure means that no intervening structure is present.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system comprising:
an LED; and
a driver circuit configured to drive the LED, the driver circuit comprising:
a shunt switch having a source terminal and a drain terminal configured to be in parallel with the LED and further configured to serve as a current shunt path for the LED when the shunt switch is closed; and
a current regulator configured to provide current to the LED when the shunt switch is opened.

2. The system of claim 1, wherein the current regulator comprises a switch, a diode, and an inductor.

3. The system of claim 2, wherein the current regulator further comprises a feedback control mechanism connected to a gate terminal of the switch.

4. The system of claim 1, wherein the shunt switch comprises a field-effect transistor.

5. The system of claim 1, wherein the system is configured to have less than about 1 microsecond rise times for the shunting of currents of greater than about 10 amps.

6. The system of claim 1, wherein the current regulator comprises a buck regulator and the buck regulator has output terminals connected to the source and drain terminals of the shunt switch.

7. The system of claim 1, wherein the current regulator has input terminals configured to be connected to a voltage source.

8. The system of claim 1, further comprising a capacitor is connected to the input terminals of the current regulator.

9. The system of claim 1, wherein the LED has a dielectric function that varies spatially according to a pattern.

10. The system of claim 9, wherein the dielectric function that varies spatially according to the pattern enhances light extraction and/or light collimation of light emitted by the LED.

11. The system of claim 1, wherein the LED is configured to emit light having a total power greater than 0.5 Watts

12. An LED driver circuit for an LED load, the circuit comprising:
a shunt switch having a source terminal and a drain terminal configured to be in parallel with the LED load and further configured to serve as a current shunt path for the is LED load when the shunt switch is closed; and
a current regulator configured to provide current to the LED load when the shunt switch is in an open configuration.

13. The circuit of claim 12, wherein the shunt switch comprises a field-effect transistor.

14. The circuit of claim 12, wherein the shunt switch is configured to have less than about 1 microsecond rise times for the shunting of currents of greater than about 10 amps.

15. The circuit of claim 12, wherein the current regulator comprises a switch, a diode, and an inductor.

16. The circuit of claim 13, wherein the current regulator further comprises a feedback control mechanism connected to a gate terminal of the switch.

17. The circuit of claim 12, wherein the current regulator comprises a buck regulator and the buck regulator has output terminals connected to the source and drain terminals of the shunt switch.

18. The circuit of claim 12, wherein the current regulator has input terminals configured to be connected to a voltage source.

19. The circuit of claim 12, further comprising a capacitor connected to the input terminals of the current regulator.

20. A method of driving an LED comprising:
driving an LED using a driving circuit comprising:
a shunt switch having a source terminal and a drain terminal configured to be in parallel with the LED and further configured to serve as a current shunt path for the is LED when the shunt switch is closed; and
a current regulator configured to provide current to the LED when the shunt switch is opened.
